(19) United States
(12) Patent Application Publication
(10) Pub. No.: US 2006/0262851 A1
(43) Pub. Date: Nov. 23, 2006

(54) Method and system for efficient transmission of communication traffic

(75) Inventors: Shay Bakfan, Netanya (IL); Hezi Manos, Givatayim (IL)

Correspondence Address: SMITH FROHWEIN TEMPEL GREENLEE BLAHA, LLC, P.O. BOX 88148, ATLANTA, GA, 30356, US

(73) Assignee: CELTRO LTD.

(21) Appl. No.: 11/408,418

(22) Filed: Apr. 21, 2006

Related U.S. Application Data
(60) Provisional application No. 60/594,926, filed on May 19, 2005.

(51) Int. Cl. H04N 7/12

(52) U.S. Cl. 375/240.12

(57) ABSTRACT

Bandwidth utilization within a cellular network is increase by reducing the amount of traffic to be transmitted, in particularly in traffic that has already been compressed. An encoded signal that comprises an umber of frame signals (or simply frames) is received and each frame is classified in accordance with one or more pre-defined characterization criterion. The characterization can include identifying the frames as speech type signals, such as voice signals or noise signal. Voice signal frames may be further characterized as a stationary frames (where the voice signal is essentially at a constant level), as a transition frame between phonemes, and the like. A noise type of frame may be further characterized as a silence frame, a background noise and the like. Video frame types can be characterized as a frame with a rapid/slow change in respect to the preceding frame, a frame with a rapid/slow change in respect to pixels in that frame, and the like. Depending on the classification of each frame, the encoded signal may be formatted and be replaced by a corresponding representation signal, wherein the number of bits comprised in a plurality of the formatted signals, is less than the number of bits comprised in the received encoded signal. Consequently, a formatted frame signal may be represented by a selected corresponding representation signal, or by a number of selected a corresponding representation signals which correspond to the sub-frame signals, and when taken together, carry the information required for the regeneration or reconstruction of the entire encoded frame signal.

### CROSS-REFERENCE TO RELATED APPLICATIONS

This patent application is a U.S. nonprovisional application filed pursuant to Title 35, United States Code §100 et seq. and 37 C.F.R. Section 1.53(b) claiming priority under Title 35, United States Code §119(e) to U.S. provisional application No. 60/594,926 filed May 19, 2005 with a title of METHOD AND SYSTEM FOR EFFICIENT TRANSMISSION OF COMMUNICATION TRAFFIC and naming Shay Bakfan and Hezi Manos as joint inventors, which application is herein incorporated by reference. Both the subject application and its provisional application have been or are under obligation to be assigned to the same entity. This application incorporates by reference U.S. patent application Ser. No. 10/830,081.

### BACKGROUND OF THE INVENTION

The present invention generally relates to communication networks, and, more particularly, to communication networks using compression techniques that result in providing or enabling a better or more efficient utilization of the available bandwidth.

The rapid evolution, development and deployment of communication networks, including wireless communication networks, for mobile communications, such as but not limited to, Global System for Mobile communications (GSM) networks, Third Generation (3G) networks, and the desire for enriched services and features over such networks, creates a demand for more bandwidth and utilization efficiency.

One way of increasing bandwidth utilization efficiency is described in U.S. Pat. No. 6,622,019, which describes a method of forwarding signals over a cellular link. The described method includes receiving, at a first base station of a cellular fixed network, a packet of signals having a data payload directed to a second base station, determining whether the data payload will eventually be used at the second base station, and forwarding the packet payload to the second base station if it will be used at the second base station and not forwarding the entire packet payload if it will not be used.

Another way of increasing bandwidth utilization efficiency is described in U.S. patent application Ser. No. 10/830,081, which describes a method for reducing the number of bits representing an encoded communication signal. The method comprises receiving an encoded communication signal represented by a plurality of frames with each of the frames comprising at least one frame signal. The frame signal is then classified and a corresponding representation signal is selected for each of the frame signals. The total number of bits comprised in a plurality of the selected corresponding representation signals is less than the number of bits comprised in said encoded communication signal. It should be noted that the terms “packet”, “frame” and “sub-frame” may be used interchangeably herein. Henceforth, the description of the present invention may use the term ‘frame’ as a representative term for any of the above group.

Some of the prior art methods use a trivial decode/encode process for formatting encoded signals into a new format that requires fewer bits. The encoded signal is fully decoded and the decoded signal is fully encoded according to another algorithm. For example, a received encoded audio signal, which was encoded according to an adaptive multi-rate (AMR) algorithm using a bit rate of 12.2 kb/sec is filly decoded. Then, the decoded audio is fully encoded according to AMR 7.95 kb/sec. However, the trivial decoded/encoded process requires computing resources and creates delay.

Due to the fact that any increase in bandwidth utilization efficiency has substantial economic effects, additional improvements are considered as highly desired.

The disclosures of all references mentioned above and throughout the present specification are hereby incorporated herein by reference.

### BRIEF SUMMARY OF THE INVENTION

Exemplary embodiments of the present invention provide a novel apparatus and improved methods that enable an increase in bandwidth utilization efficiency in communication networks. An exemplary embodiment of the present invention may be used in fixed networks of cellular based wireless telecommunication networks for mobile applications.

One embodiment of the present invention enables a reduction in the amount of traffic to be transmitted, in particularly in traffic that has already been compressed.

In another embodiment of the present invention, when an encoded signal that comprises a number of frame signals (or simply frames) is received, each frame is classified in accordance with one or more pre-defined characterization criterion. Each characterization criteria is, for example, the following: if the frame is identified to comprise a speech type signal, the frame could be characterized as either being a voice signal frame or a noise signal frame. A voice signal frame may be further characterized as a stationary frame (where the voice signal is essentially at a constant level), as a transition frame between phonemes, and the like. A noise type of frame may be further characterized as a silence frame, a background noise and the like.

Another type of frame is a video frame, which can be characterized as a frame with a rapid/slow change in respect to the preceding frame, a frame with a rapid/slow change in respect to pixels in that frame, and the like. Preferably, such a classification process may be carried out also at a sub-frame level, so that one frame may contain more than one classification, where each of the classifications is based on the characterization of the corresponding part of the frame. An exemplary sub-frame may be a portion of a frame, such as, but not limited to, a quarter of a frame, a half frame, etc.

Depending on the classification of each frame or sub-frame, the encoded signal may be formatted and be replaced by a corresponding representation signal, wherein the number of bits comprised in a plurality of the formatted signals, is less than the number of bits comprised in the received encoded signal. Consequently, a formatted frame signal may be represented by a selected corresponding representation signal, or by a number of selected a corresponding representation signals which correspond to the sub-frame signals, and when taken together, carry the information required for the regeneration or reconstruction of the entire encoded frame signal.

In one exemplary embodiment of the present invention, formatting the encoded signal may be based on non-standard format. In such an embodiment a receiving end is required. The receiving end may receive the formatted signal, process the formatted signal and convert the formatted signal back into a standard format before forwarding it toward its final destination.

In an alternate exemplary embodiment of the present invention, the formatting process of the encoded signal is based on a standard format. For example, if the received encoded signal was encoded according to an adaptive multi-rate (AMR) algorithm at 12.2 kbit/sec, then formatting may be done according to AMR algorithm at 7.95 kbit/sec. Another example may include a received encoded speech signal that has been classified as a noise or a silence signal. Then the formatted signal may represent a standard SID (Silence Descriptor) frame, etc.

In such an exemplary embodiment of the present invention a device at the receiver end of the connection is not needed and the formatted signal may be sent as is all the way to the final destination of the received encoded signal.

The foregoing summary is not intended to summarize each potential embodiment or every aspect of the present disclosure, and other features and advantages of the present disclosure will become apparent upon reading the following detailed description of the embodiments with the accompanying drawings and appended claims.

Furthermore, although specific exemplary embodiments are described in detail to illustrate the inventive concepts to a person skilled in the art, such embodiments are susceptible to various modifications and alternative forms. Accordingly, the figures and written description are not intended to limit the scope of the inventive concepts in any manner.

### BRIEF DESCRIPTION OF THE SEVERAL VIEWS OF THE DRAWING

Exemplary embodiments of the present invention will be understood and appreciated more fully from the following detailed description, taken in conjunction with the drawings in which:

FIG. 1 is a simplified block diagram illustration of an exemplary portion of a communication network in which an exemplary embodiment of the present invention can be installed.

FIG. 2 is a simplified block diagram illustration of the communication network of FIG. 1 including exemplary embodiment of the present invention;

FIG. 3 schematically illustrates a Formatter/De-Formatter Transmitter/Receiver Module (FDTRM) operative according to certain teachings of the present disclosure.

FIG. 4 schematically illustrates a Standardized Formatter Transmitter Unit (SFTU) operative according to alternate teachings of the present disclosure.

FIG. 5 illustrates a flowchart showing an embodiment of a process for classifying incoming frames;

FIG. 6 illustrates a flowchart showing an embodiment of a process for formatting incoming frames; and

FIG. 7 illustrates a flowchart showing an embodiment of a process for de-formatting outgoing frames.

### DETAILED DESCRIPTION OF THE INVENTION

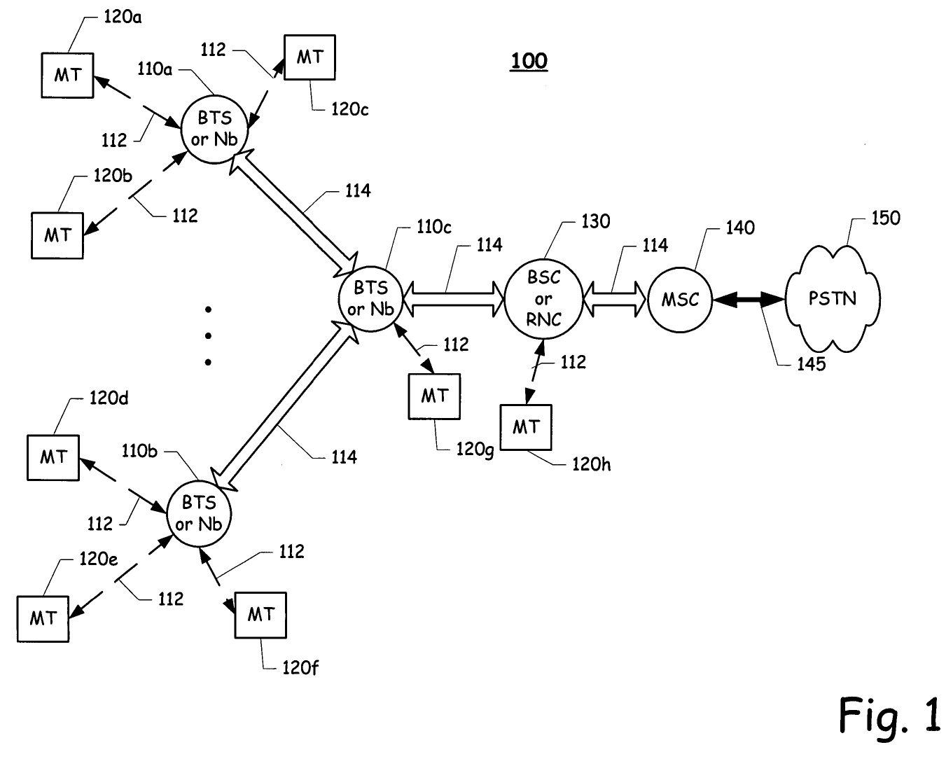

FIG. 1 illustrates a block diagram of a portion of an exemplary cellular network 100. Network 100 may comprise a plurality of base transceiver stations (BTSs) 110a-c, which operate to wirelessly connect the mobile terminals (MT) 120a-h serviced by the network 100. BTSs 110a-c are connected to a regional base station controller (BSC) 130, through a plurality of links 114 which may comprise cable wires (e.g. an E1 link), fiber optics, or other communication links, such as wireless omni-directional links, etc. In a 3G network, a BTS 110a-c is replaced by a node base station (Nb) and a BSC 130 is replaced by a Radio Network Controller (RNC). One or more BSCs 130 may be connected to a mobile switching center (MSC) 140.

Each link 114 may comprise one or more tunnels, which are formed of a plurality of channels. In 3G networks, the communication between the RNC 130 and the different Nbs 110a-c, over the communication links 114, may be encrypted. The communication between the MSC 140 and the RNC 130 is typically not encrypted. A common BSC or RNC 130 may also communicate directly with one or more MTs 120a-h that are located in its area (cell). In various embodiments, environments or implementations, an MT 120 can be a cellular telephone or handset, a PDA with cellular capabilities, or any other computerized device that can generate and/or receive audio, video, data or any combination of those via a cellular network.

Among other tasks, the MSC 140 may serve as an interface between the cellular network 100 and one or more Public Switched Telephone Networks (PSTN) 150 via communication link 145. The MSC 140 may comprise one or more codec devices. The codec may be used to compress (encode) audio coming from a regular telephone via the PSTN 150 and targeted to one of the MTs 120a-h that are connected over network 100. In the other direction, the codec may be used to decompress (decode) compressed audio coming from one of the MTs 120a-h and targeted to a regular telephone (not shown) that is connected over the PSTN 150. The codec at the MSC 140 may be used as an initiator of compressed audio or as a receiving entity for compressed audio depending on the direction of the transportation. There are some embodiments in which a BSC 130 may have some of the functionality of the MSC 140. Although the separation of this functionality into the identified components may in and of itself be novel, various aspects and embodiments of the present invention are not limited to the illustrated separation.

When an MT 120 is an active participant in a telephone call, BSC 130 may allocate a connection from the BSC 130 to the BTS 110 servicing the particular MT 120. The allocated connection is formed of a dedicated channel(s), which is used only for signals passed to and/or received from the MT 120 to which the connection was allocated. This allocation remains in effect until the telephone call is terminated. During the call, the MT 120 converts input audio signals into digital signals. Because the use of wireless bandwidth is very costly, the digital signals are compressed (encoded) by the MT 120, and the compressed signals are transmitted to the servicing BTS. In an exemplary codec, such as but not limited to an AMR codec, the digital signals are divided into frames. Each frame is encoded. Each frame represents the sounds collected by the MT 120 during a time period of the frame, a period of 20 msec, for example.

The servicing BTS (or Nbs) 110a-c passes the compressed signals as they are (i.e., without decompressing them) to the BSC or RNC, over the MT's dedicated channels and from there to the MSC 140. Generally, the digital signals are organized in frames and each frame comprises a header and a compressed payload. More information on cellular networks can be found in the United States patent and patent application that were mentioned above, or in relevant web sites such as www.etsi.org or www.3gpp.org. The content of which are incorporate herein by reference.

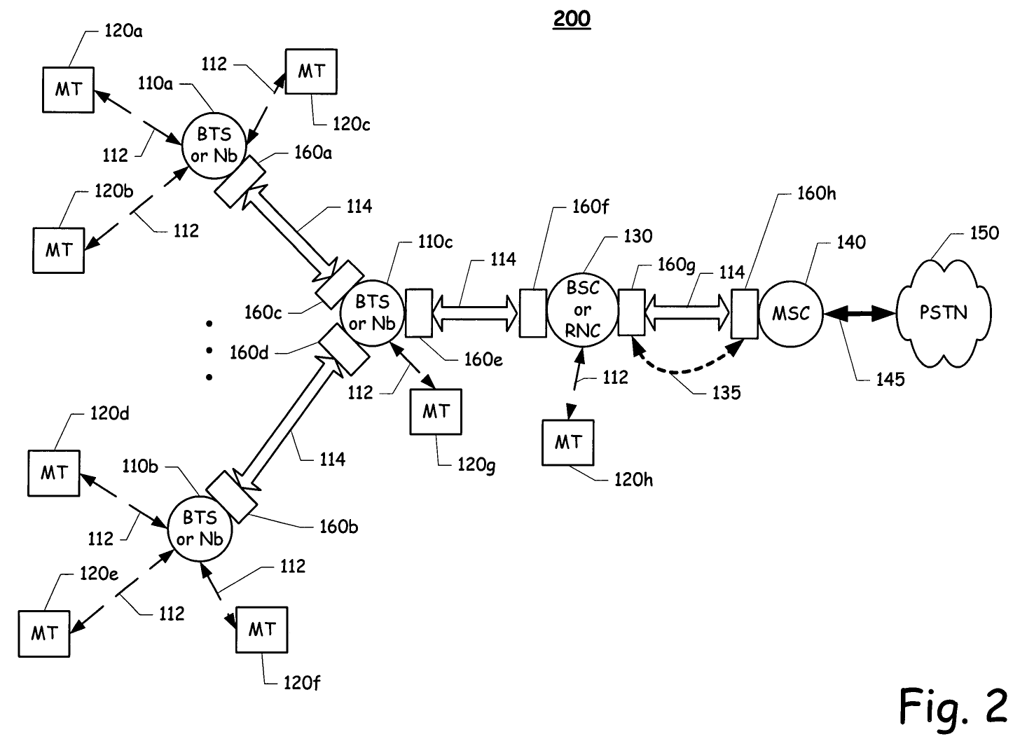

FIG. 2 illustrates a block diagram of a portion of an exemplary cellular network 200 in which exemplary embodiments of the present invention are used to increase the bandwidth efficiency of the cellular fixed network 100 that is disclosed above in conjunction to FIG. 1. Network 200 may comprise a plurality of formatter devices 160a-h. Formatter devices 160a-h are used to format compressed payloads of packets in order to reduce the number of bits contained therein and thus, to increase the bandwidth utilization of the fixed network 200.

In one exemplary embodiment of the present invention, the formatter devices 160a-h can be a Formatter/De-Formatter Tx/Rx unit (FDTRU). In such an embodiment, each end of a communication link 114 is terminated with an FDTRU. Selected encoded packets coming through or from a base station (BS) are formatted by the FDTRU, which resides in the junction of the BS and the relevant communication link 114, before being transmitted over communication link 114. A base station (BS) can be a BTS 110a-c, a BSC 130 or an MSC 140. On the other end of the communication link 114, the formatted packets are received by the other FDTRU. The FDTRU, on the other end, operates to de-format the received formatted packets and transfers the de-formatted packets, which are similar to the original encoded packets, to its associated BS.

In an alternate exemplary configuration of network 200, some of the formatter devices 160 may be eliminated. For example, in the embodiment illustrated in FIG. 2, formatter devices 160c and 160d may be removed. In this configuration, formatter device 160e may format/de-format frames coming/going from/to MT 120g and may transfer frames coming/going from/to MT 120a-f in their current state.

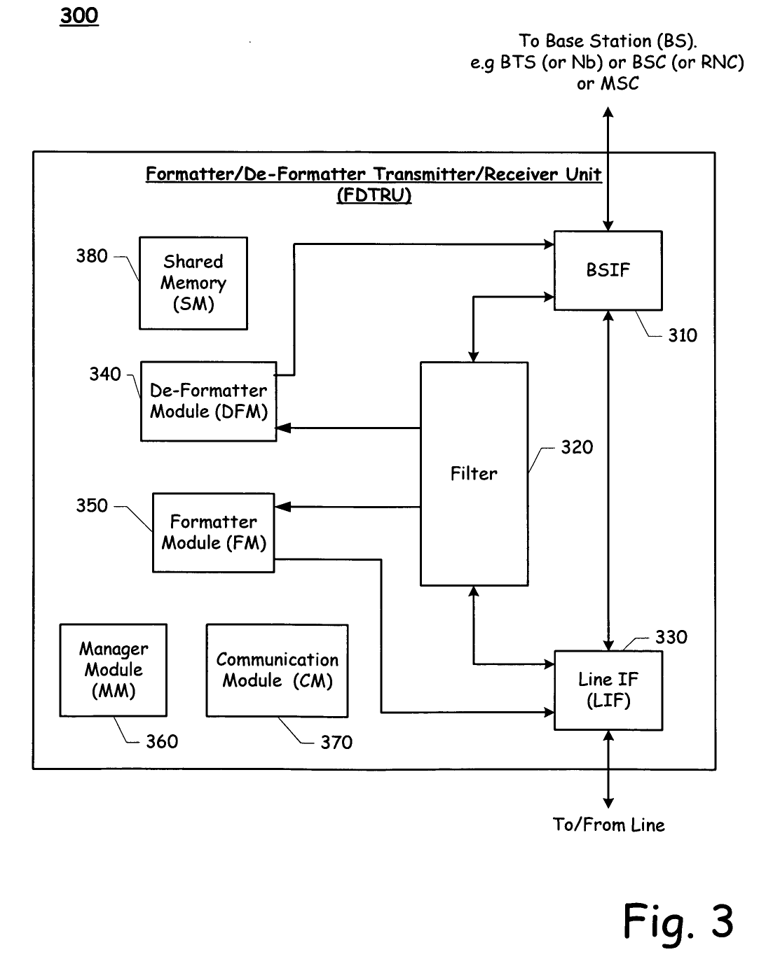

In another exemplary embodiment of the present invention, in which FDTRUs are used, de-formatting may be done once at the FDTRU that is associated with the BS to which the packet is targeted. For example if a packet is sent from MT 120c to MT 120h, then formatting may be done by formatter device 160a and de-formatting may be done by formatter device 160f. In other case, suppose the communication is between a regular telephone (not shown) and MT 120g. In this example, compressing and packetizing may be done by MSC 140, formatting of the compressed packet can be done by formatter device 160h and de-formatting by formatter device 160e. More information on the operation of FDTRU is disclosed below in conjunction with FIGS. 3, 5 and 6.

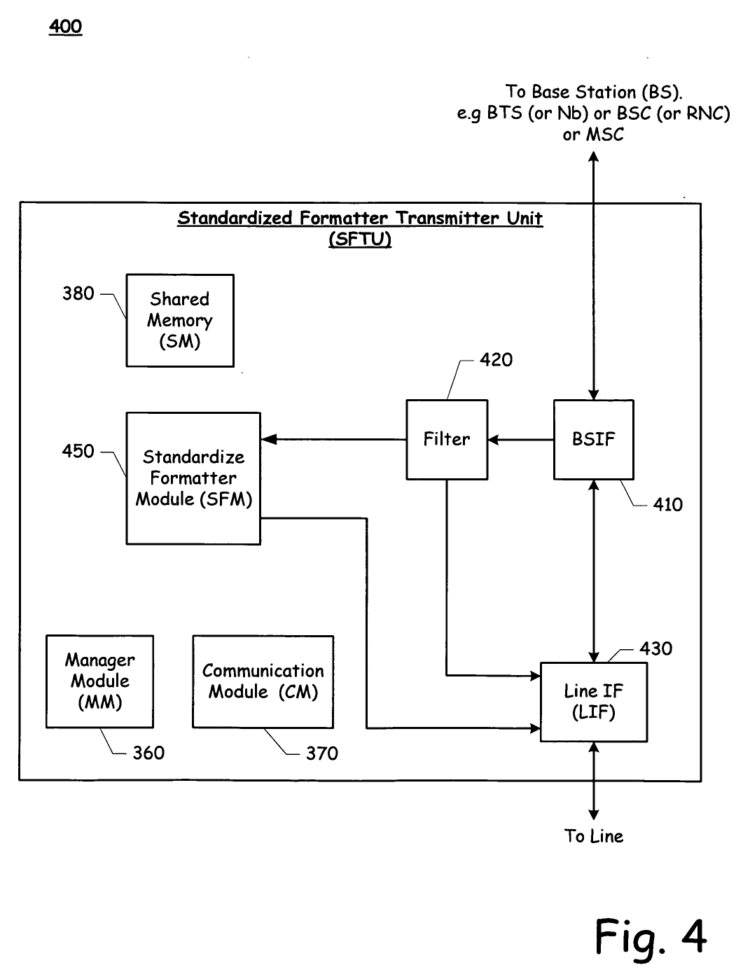

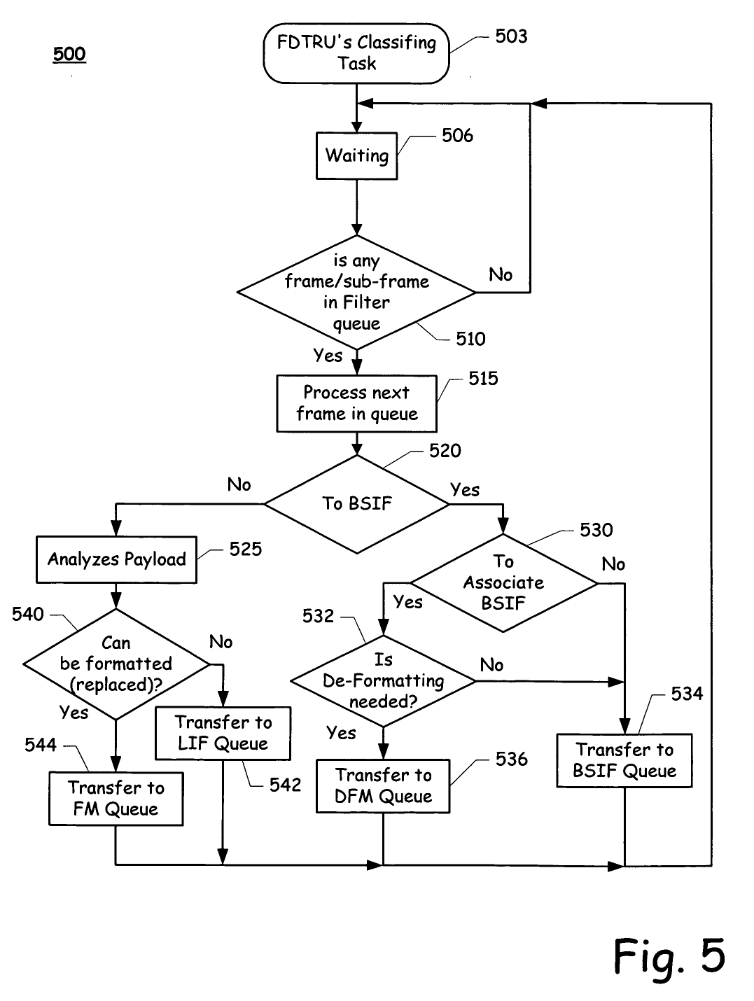

In a further alternate exemplary embodiment of the present invention, network 200 may utilize a Standardized Formatter Transmitter Unit (SFTU) as the formatter devices 160a-h. The SFTU may use a standard format for formatting received encoded signals. Therefore, the formatted packet may be sent as is to its final destination without the need to be de-formatted. For example if a packet is sent from MT 120f to MT 120h, then formatting may be done by SFTU 160b and the formatted packet may be sent as is to MT 120h. More information on the operation of SFTU is disclosed below in conjunction with FIGS. 4 and 5.

In yet another exemplary embodiment of the present invention, a formatter device 160 may have the functionality of an FDTRU and SFTU. In such an embodiment, a decision whether to use a standard format or non-standard format can be based on the encoded standard that was used to encode the received encoded signal.

When the underlying network 200 is a 3G network, the transportation between the RNC 130 and the different MTs 120a-h can be encrypted while the transportation between the RNC 130 and the MSC 140 is not encrypted. In one exemplary embodiment of the present invention, an SFTU may be installed over the link 114 between the MSC 140 and the RNC 130 (e.g., block 160g). Over this link the transportation is not encrypted and therefore, the SFTU may format the downstream transportation and increase the capacity of the network in the direction from the MSC 140 to the MT 120a-h. However, in such an embodiment the upstream transportation is not formatted and the system is partially used.

In an alternate embodiment of the present invention, the formatter device 160g, which is installed on the communication link 114 between the RNC 130 and the MSC 140, can be adapted to obtain ciphering keys and ciphering parameters that are required to cipher/decipher the transportation between the RNC 130 and the different MTs 120a-h. The ciphering keys and ciphering parameters can be received from the operator of the network, through a public key distribution technique or other technique known to those skilled in the art. In such an embodiment, one or more formatter devices 160a-f (an FDTRU or SFTU) can be installed in association with each one of the Nbs 110a-c. The formatter device 160g may inform the other formatter devices 160a-160f about the ciphering keys and ciphering parameters that are used by the MTs 120a-h that are currently served by them. Each one of those formatter devices is adapted to decrypt a received frame before starting the entire formatting process and to encrypt the formatted frame before sending it to the next location or hop. In this application the terms “cipher” and “encrypt” are used interchangeably and the terms “decipher” and “decrypt” are used interchangeably.

FIG. 3 illustrates a block diagram of an exemplary embodiment of a Formatter/De-Formatter Transmitter/Receiver Unit (FDTRU) 300. The FDTRU 300 can be installed between a base station (BS) and a communication link 114 that carries communication to/from the BS. A BS can be a BTS 110a-c, a BSC 130 or an MSC 140. An exemplary FDTRU 300 can comprise a Base Station Interface Module (BSIF) 310, a Line Interface Module (LIF) 330, a Filter 320, a Formatter Module (FM) 350, a De-Formatter Module (DFM) 340, a shared memory (SM) 380, a Manager Module (MM) 360 and a communication module (CM) 370.

A “module” may be a stand-alone unit or a specialized or integrated module. A unit or a module may be modular or have modular aspects allowing it to be easily removed and replaced with another similar unit or module. Each unit or module may be any one of, or any combination of, software, hardware, and/or firmware. The different modules may communicate with each other via a common interface. The common interface can be a bus, such as but not limited to, a TDM bus, a packet based bus, etc. or a shared memory. In the non-limiting example of FIG. 3, a shared memory 380 is used as a common interface between the different modules. The FDTRU 300 may be embedded in a single server or in two or more servers depending on the load at a certain node.

The BSIF 310 operates as an interface module between the FDTRU 300 and the connection to the BS. In the direction coming from the BS, the BSIF 310 receives the packets (frames or sub-frames); and parses the received frame or sub-frames according to the communication protocol that is used over the communication link 114. The parsed frame or sub-frame, which includes header and payload data, can be stored in the SM 380. Then, the BSIF 310 determines whether to transfer the received frame or sub-frame, as is, to the LIF 330 or to transfer the parsed frame or sub-frame to the filter module 320 for further processing. This decision may be based on several criteria.

One exemplary criterion can be the communication activity level along the communication path of the frame or sub-frame. The communication path can be the communication link 114 (FIG. 2) that is connected to the other side of the FDTRU 300 or the highest communication activity level of several communication links 114 that exist along the path from the FDTRU 300 to a FDTRU that is installed close to the BS to which the frame or sub-frame is targeted. Information on the communication activity level can be received from the MM 360. More information on the communication activity level is disclosed below in conjunction with the MM 360. If the communication activity level along the communication path is below a certain limit, then the frame or sub-frame is transferred, as is, to the LIF 330 and from there to the communication link 114 (FIG. 2).

If the communication activity level is above the certain limit, then the payload of the parsed frame or sub-frame can be checked, and if the payload is not encoded audio or video the frame or sub-frame is transferred as is to LIF 330 and from there to the communication link 114 (FIG. 2). If the payload is encoded audio or video, then the parsed frame or sub-frame is transferred to the filter 320 for further analyzing.

Transferring the parsed frame or the original frame between the different modules can be done by placing a pointer, which indicates it's location in the SM 380, in a queue that is associated with the module to which the frame or sub-frame is transferred. In an alternate embodiment of the present invention, the communication between the internal modules may be done over an internal bus.

In the other directions, packets (frames or sub-frames) coming from the communication link 114 to the BS may be transferred to the BSIF 310 directly from the LIF 330 or from the filter 320 (frame or sub-frames that do not need the de-formatting process)—those frames or sub-frames are transferred as is to the BS. The BSIF 310 may also get de-formatted frames coming from the DFM 340. The BSIF 310 may organize the de-formatted frames according to the communication protocol that is used over link 114. The header of the frame or sub-frame may be adapted to include the changes in the payload, which are due to the formatting/de-formatting process. For example, a checksum bit may be recalculated; frame size information may be corrected, etc. Then, the re-formatted frame or sub-frame is sent to the BS.

In an exemplary FDTRU 300, which is adapted to operate in a 3G network, the BSIF 310 can be adapted to decrypt an incoming frame or sub-frames before parsing the frame or sub-frames. The outgoing frame or sub-frames can be encrypted at the end of the process before transferring them toward the BS.

The LIF 330 is an interface module between the FDTRU 300 and the communication link 114. In the direction coming from the link 114, the LIF 330 receives the packets (frames or sub-frames); and parses the received frame or sub-frames according to the communication protocol that is used over the communication link 114. The parsed frame or sub-frame, which includes a header and a payload, can be stored in the SM 380. Then, the LIF 330 determines whether to transfer the received frame or sub-frame as is to the BSIF 310 or to transfer the parsed frame or sub-frame to the filter module 320 for further processing. This decision may be based on several criteria.

In one exemplary embodiment of the present invention, a tag (formatted tag) may be added to a formatted payload. In such an embodiment, the LIF 330 may be adapted to check the existence of the formatted tag. If the formatted tag is missing or has not been active, then the received frame or sub-frame is transferred as is to the BSIF 310 and from there to the BS. If the formatted tag exists or has been activated, then the frame or sub-frame is transferred to the filter 320 for further processing. In an alternate embodiment of the present invention in which a formatted tag is used, a parsed frame or sub-frame that has a formatted tag may be transferred directly to the DFM 340 skipping the filter 320.

Yet in another exemplary embodiment of the present invention, the LIF 310 may determine to which BS the frame or sub-frame is targeted. If the target BS is not the BS that is associated with the current FDTRU 300 then the frame or sub-frame is transferred as is to BSIF 310.

In an alternate embodiment of the present invention in which a formatted tag is not used, then the payload of the parsed frame or sub-frame is checked and if the payload is not encoded audio or video then the packet is transferred as is to the BSIF 310 and from there to the BS. If the payload is encoded audio or video then the parsed frame or sub-frame is transferred to the filter 320 for further analyzing.

In the other directions, from the BS to the communication link 114, the LIF 330 may get frame or sub-frames directly from the BSIF 310 or from the filter 320 (frame or sub-frames that have been defined by the filter as un-formatted frame or sub-frames); and those frames or sub-frames are transferred as is to the communication link 114. The LIF 330 also gets formatted frames or sub-frames from the FM 350. The LIF 330 may organize the formatted frames according to the communication protocol that is used over link 114. The header of the formatted frames or sub-frames may be adapted to include the changes in the formatted payload, which are due to the formatting process. For example, a checksum bit may be recalculated; frame size information may be corrected, etc. Then, the formatted frame or sub-frame is sent over the communication link 114.

In one direction, the filter 320 may receive a parsed frame or sub-frames coming from the BSIF 310 and then determine whether to forward the parsed frame or sub-frame to the FM 350 or to the LIF 330. In the other direction, the filter 320 may receive a parsed frame or sub-frames coming from the LIF 330 and then determine whether to forward the parsed frame or sub-frame to the DFM 340 or to the BSIF 310. The decision process of the filter 320 may be based on several criteria. In an exemplary embodiment, the criteria may include the destination address of the packet, optionally and or additionally a de-formatted payload, classification of the content of the payload (i.e., is it encoded speech frame/sub-frame or encoded noise (SID) frame/sub-frame), and the type of encoded speech frame/sub-frames (echo, silence, pure-speech), etc.

Usually, received encoded noise (SID) frames/sub-frames do not require additional classification. In one exemplary embodiment of the present invention, the received encoded noise (SID) frame/sub-frame can be transferred as is to the LIF 330. In another exemplary embodiment of the present invention, the received encoded noise (SID) frames/sub-frame may be transferred to the FM 350 and be formatted in a similar way to encoded speech frames/sub-frames that have been classified as noise.

In some exemplary embodiments of the present invention, only part of received successive SID frames is transferred. On the other end of the connection at the receiving FDTRU 300, the missing SID frames may be reconstructed by repeating previous transferred SID frame.

In order to further classify encoded speech frames/sub-frames for defining some of the criteria that are associated with the type of the payload, in one exemplary embodiment of the present invention the encoded audio stream is parsed (partially decompressed) and some of the encoded stream parameters (encoded parameters), such as but not limited to, Pitch Gain and Fix Code Book Gain, etc., are retrieved and then analyzed to classify the frame or sub frame. More information on the filtering and classification process is disclosed in conjunction with FIG. 5.

In an alternate embodiment of the present invention, the filter 320 may not be included. In such an embodiment, the filtering process may be accomplished by the BSIF 310 and FM 350 for frames or sub-frames coming from the BS and by the LIF 330 and the DFM 340 for frames or sub-frames coming from the communication link 114. Yet in another exemplary embodiment of the present invention, a received encoded signal may be formatted without being classified.

The FM 350 receives parsed frames coming from BSIF 310 via the filter 320. The parsed frames may be associated with some classification about their type. The FM 350 may further analyze the payload for further classification. Based on the classification of the payload and the content of the payload, the payload may be formatted and be replaced by corresponding representation information. The corresponding representation information can later be used by a DFM 340 at a receiver FDTRU to de-format the received frame or sub-frames. The formatted frame or sub-frames include fewer bits than the original frame or sub-frames.

Further classifying of the type of an encoded speech frames/sub-frames may be done by parsing or partially decompressing the encoded signal of a received frame, or a sub-frame. To reduce delay, parsing or partially decompressing a sub-frame may be started and terminated before receiving the entire frame. Voice encoded parameters are retrieved from the encoded stream. The voice encoded parameters may include parameters, such as but not limited to: line spectrum frequency (LSF), Pitch Gain, Fix Code Book Gain, pitch period, pulse position, etc. It should be noted that the terms “pitch period”, “pitch delay” and “pitch lag” may be used interchangeably herein.

Classifying the encoded speech frame or sub-frame may be based on the retrieved parameters. Two main categories may be used, (a) new noise frame or sub-frame or (b) speech frame or sub-frame. A new noise frame is a frame that was originally encoded by the initiator of the encoded audio as a voice frame and not as a noise or silence frame. The classification decision may be based on the pitch period and/or the energy (voice activity parameters). A speech frame or sub-frame may be further classified into additional categories, including but not limited to, stationary voice, non-stationary voice, echo, etc.

The signal energy of a received encoded frame may be calculated based on a parameter, which can be referred to as a total gain (TG). The TG may be calculated based on the retrieved Pitch Gain and the retrieved Fix Code Book Gain. The TG can be proportional to the sum of those parameters, for example. FM 350 may store some or all parameters and may use the stored parameter in processing the following frames coming from the same source. The information may be stored in the SM 380. For example, the pitch delay may be stored for future use. The differences between a current pitch delay to previous ones may be used to define noise versus speech, etc. Comparing the current pitch period, with or without one or more gain parameters, to previous ones may be used to define stationary voice, non-stationary voice, echo, etc. For example, frames or sub-frames having a TG that is lower than a certain level may be classified as noise (new noise) although the received encoded frame or sub-frame has been encoded as speech. In another case, if the difference between pitch lag of consecutive frames or sub-frames is below a certain number of samples (3, 4, 5, etc.), then the frame or sub-frame c an be classified as stationary voice, etc. For example, an echo frame can be identified by a TG parameter that is in a certain range above noise but below voice. A sequence of frames or sub-frames having harmonic pitch (the ratio between its pitches is an integer number) can be defined as voice frame or sub-frame respectively, for example.

Based on the classification of the frame or sub-frame, the FM 350 may select or calculate a corresponding representation signal that will replace the original signal. The corresponding representation signal may not belong to any standard format, and therefore on the other end of the connection a DFM 340 is required. Following are few exemplary non-standard corresponding representation signals.

For example the corresponding representation of a frame or sub-frame, which has been classified as a new noise, may include only the LSF and the TG parameters of the received encoded signal, the rest of the payload can be discarded. In addition a tag may be added to indicate that the payload is a formatted payload of a new noise frame. The formatted noise frame (or sub-frame) may be sent for each received frame.

In an alternate embodiment of the present invention, the FM 350 may send a corresponding representative signal to replace a first frame or sub-frame of new noise, then discarding one or more subsequent and consecutive frames that have been classified as noise. The representative frame with new noise is resent or the FM 350 may simply wait and send a first received speech encoded frame that follows the one or more frames that have been classified as noise.

Following is an exemplary embodiment for the transmission of corresponding representation signal for a frame that was marked as a stationary voice frame. The FM 350 may use corresponding representation signals that are related to relevant parameters of one or more previous frames. To preserve the quality of the reconstructed encoded voice signal, the number of stationary frames may be limited to only a few frames, (e.g. four frames). In this example, every fourth frame is transferred as is and is used as a base frame for the following three frames. Other exemplary embodiments may use other number of frames, (e.g. 5, 6 etc.). The frame that is transmitted as is referred to as a base frame. Then, per each following frame or sub-frame, the difference between the value of one or more parameters of the current frame are compared to the previous frame or to the base frame, and only the difference is used as a representative signal. The difference of the value of the current pitch gain compared to the base pitch gain is used, for example. In addition, a tag may be added to the formatted payload to indicate that the payload is of a base frame. Another tag may be used to indicate that the formatted payload belongs to differential frame or sub-frame.

For example, a current pitch delay can be replaced by the difference of the current pitch delay from the previous one; the current pitch gain is replaced by the difference of the current pitch gain from the previous one, etc. Because the difference is smaller than the original value, a lower resolution may be used to reduce the number of bits that represent the encoded signal.

In an alternate embodiment, a decision on the number of frames between sequential base frames may be adapted to the magnitude of the difference. If the difference from the base frame/sub-frame is higher than a certain value, then a new base frame may be sent.

Alternatively or additionally, an exemplary embodiment of the present invention may reduce one or more pulses in a received encoded frame that was classified as a stationary voice frame. In an alternate exemplary embodiment of the present invention, reducing the number of pulses may be executed once every X number of frames, independent of the classification, whether the voice frame is stationary or non-stationary. The value of X can vary, and in exemplary embodiments may be in the range of 3 to 8 frames, although other values may also be used. The particular value of X in any given embodiment may be dependant on the communication activity over the communication path. As such, it will be appreciated that in some embodiments, the value of X may be adjusted based on historical information, predicted information, real-time information or a combination of two or more of these elements.

Two exemplary methods for reducing the number of pulses in a received encoded frame are presented. In one example, two pulses with opposite signs and having the smallest distance between them can be dropped. In the case of using AMR as the encoded standard, then if the dropped pulses belong to different tracks, then the rest of the pulses are rearranged to generate a complete number of tracks. Each one of the remainder pulses of the two missing tracks are moved to a location that format a new track with another pulse. The result is a lower number of pulses than the original number of pulses. For example, when using compression algorithm AMR 12.2, the number of pulses may be reduced from ten pulses (five tracks) to eight pulses (four tracks).

In another example, the FM 350 may replace two or more pulses having the same sign with a pulse that locates in an average position compared to the replaced pulses with the same sign (an average pulse).

In addition, bits may be added to include information on the formatted process as mentioned above in conjunction with the different tags.

At the end of the formatting process, the formatted frame or sub-frame is transferred to the LIF 330 to be organized according to the communication protocol and is then transmitted over communication link 114 (FIG. 2) thereby reducing the number of communicated bits in comparison to the compressed signal, which results in an increase in bandwidth utilization efficiency.

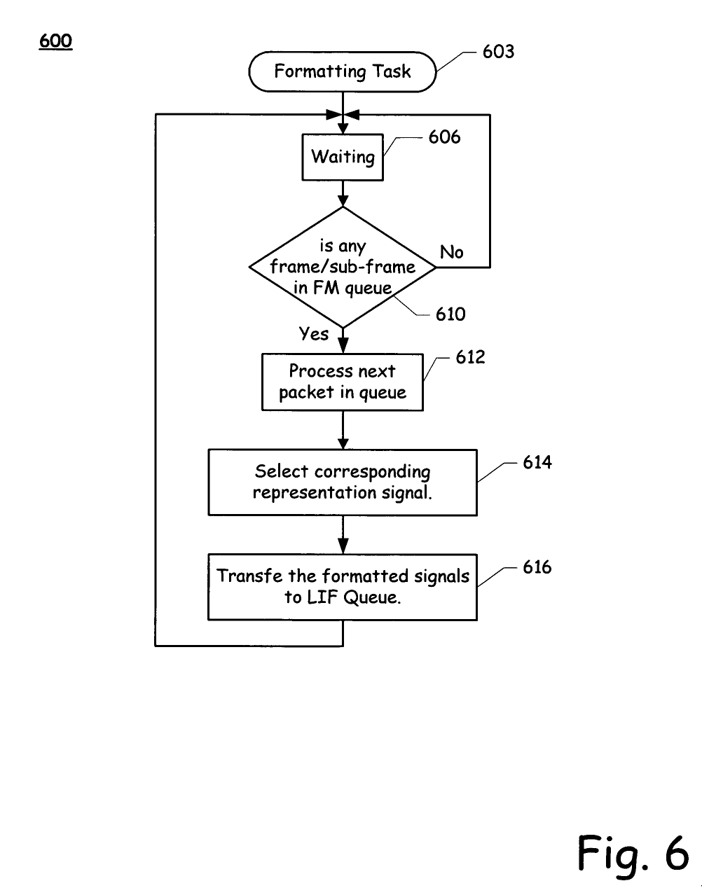

To reduce delay, parsing or partially decompressing a sub-frame, classifying the sub-frame, formatting the encoded payload and transmitting the formatted signal may be started and terminated before receiving the entire frame to which the sub-frame belongs. More information on the classification and formatting process is disclosed below in conjunction with FIGS. 5 and 6.

The DFM 340 receives parsed formatted frames coming from the LIF 330 via the filter 320. The payload of the formatted frames may include bits that include information on the formatted process that created the formatted payload as described above in conjunction to the different tags. Based on the formatting process tags, the content of the payload, and in some cases also on the history of the received formatted signal, the formatted payload may be de-formatted (converted back) into a standard format, wherein the de-formatted signal gives a similar experience to a receiver user as the original relevant encoded frame. Following are few examples of a de-formatting process for converting a non-standard encoded payload into a standard formatted encoded payload.

In one example, if a formatted frame or sub-frame was marked with a noise tag and includes only parameters such as LSF and the TG, then the DFM 340 may select random parameters to be merged with the received LSF and TG. These random parameters may include, but are not limited to the pitch, delay, pulse position, etc. This merging of the random parameters with the received LSF and TG facilitates the reconstruction of a standardized noise signal. The de-formatted (reconstructed) noise signal provides a similar experience to the listener as the original received encoded signal.

As another example, if consecutive frames of encoded noise have been discarded, then the DFM 340 may receive the first formatted frame of noise, convert (reconstruct) it into a standard encoded noise frame (as disclosed above) and repeatedly use the reconstructed noise frame, instead of the discarded one or more frames of encoded noise. This can be performed until receiving another type of formatted signal of a frame or sub-frame.

If the formatted tag indicates that the formatted payload belongs to a base frame or sub-frame of stationary speech, then the base frame is stored in the SM 380 to be used for de-formatting the next formatted frame. In parallel to this, the base frame is transferred as is to the BSIF 310. The next formatted payload has the tag of differential frame or sub-frame. Next, the reconstructed parameters of the de-formatted frame or sub frame may be calculated based on the stored parameters of the base frame and the received differences. The result of this process is a de-formatted frame that gives a similar experience to the user as the original received encoded signal. The de-formatted frame may be stored in the SM 380 instead of the base frame and can be used during the de-formatting process of the next for matted frame or sub-frame. In parallel, the de-formatted frame is transferred to BSIF 310 and from there to the BS as it is disclosed above.

If the formatted tag indicates that the formatted payload is stationary voice that has been formatted by reducing one or more pulses, then the missing one or more pulses may be created by the DFM 340. For example, two close pulses with opposite signs can be added into the signal at positions zero and one. Then the two pulses can be rearranged with the existing pulses to create new standard locations (5 tracks for the example of AMR 12.2). For example one of the pulses from track 1 can be moved to track zero to create the missing track.

If the formatted tag indicates that the formatted payload is voice (stationary or non-stationary) that has been formatted by replacing a pair of pulses with an average pulse, then the missing one or more pulses may be created by the DFM 340. The DFM 340 may add two pulses; one on each side of the average pulse, in the appropriate location that the averaged pulse can be removed. Then the pulses may be rearranged in appropriate positions.

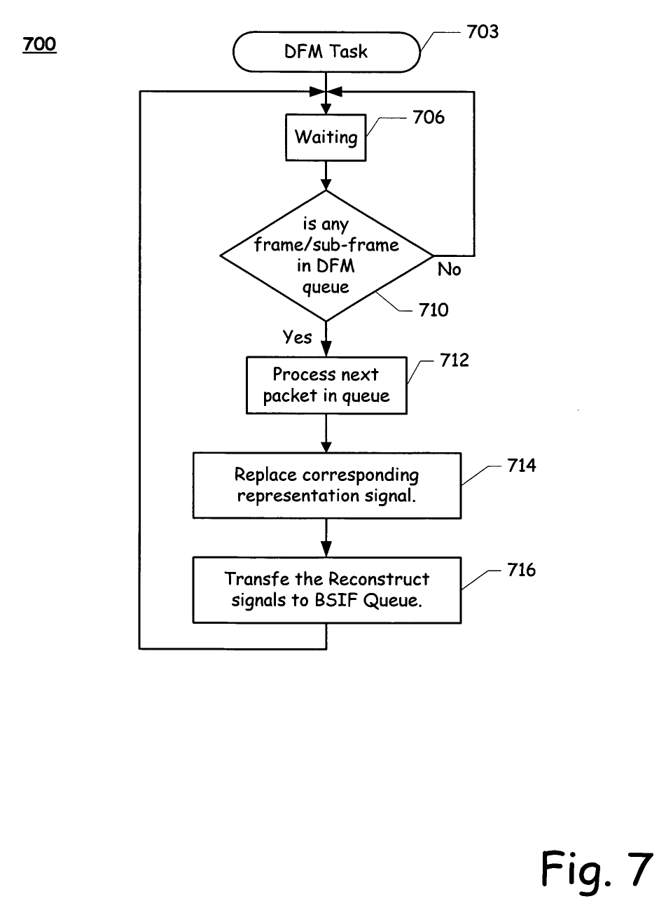

The de-formatted frame or sub-frame is transferred to the BSIF 310 to be organized according to the communication protocol that is used over communication link 114 and from there it is sent to the BS. More information on the de-formatting process is disclosed below in conjunction with FIG. 7.

The Manager Module (MM) 360 is the module that manages the operation of the FDTRU 300. During initiation of the FDTRU 300, MM 360 may create and allocate resources to the different modules 310 to 380, configure the shared memory 380, inform each one of the relevant modules about the location of the relevant queues in the SM 380, etc. The queues can be used for the communication between the different modules. The MM 360 may communicate with other FDTRUs 160 (FIG. 2) that are installed over the network 200 (FIG. 2) and with an operation management center of network 200. The communication can be done via the CM 370. The communication may be done over an IP network, over the connection lines 114, or over any other type of network capable of carrying the communication between the FDTRUs. The communication between the different modules may include signaling, information on the communication activity in each node, type of formatting process, etc.

In addition to its other tasks, the MM 360 can monitor the communication activity level over the communication link 114. Different methods may be used to define the communication activity level over a certain communication link 114 (FIG. 1). In an exemplary embodiment, the communication activity level over a communication link 114 may be defined as a certain percentage of the total capacity of the communication link 114. The total capacity of the link can be defined as the maximum bandwidth of the link. In other embodiment, the total capacity of the link can be defined as total number of different calls that can be conducted simultaneously over the link. Other embodiments may use both parameters (bandwidth and the number of calls) and calculate two communication activity levels, one for each parameter. In such a case, the biggest communication activity level can be compared to a communication activity threshold. It should be appreciated that although the above-listed configurations may in and of themselves be considered novel, in various embodiments of the present invention, other criteria in addition to or in lieu of the afore mentioned criteria may be used to define the communication activity level.

The information about the communication activity level can be shared between the different formatter devices 160 (FIG. 2). Each MM 360 may be aware of the communication activity level over the different communication links 114. In another exemplary embodiment of the present invention, the information on the communication activity level is monitored and reported to the different formatter devices 160 by the operator of the cellular network 200.

The MM 360 may compare the current communication activity level to a communication activity threshold and based on the result, internal routing decisions can be made and routing instructions transferred to the BSIF 310 and filter 320. If the communication activity level is below the communication activity threshold, then incoming frame or sub-frames are transferred directly to the LIF 330. The threshold can be defined as a certain percentage from the total capacity of the link. Exemplary values can be in the range of 40 to 70% of the total capacity.

The CM 370 is the communication interface module between the FDTRU 300 and the other FDTRUs or the operator of the cellular network. The communication includes control, signaling and status. The communication does not include cellular transportation. The communication may be done over an IP network, such as but not limited to, a LAN, WAN, Internet, global network, etc.

The shared memory 380 is used as an exemplary common interface between the different modules of FDTRU 300. Via the SM 380, data can be transferred between the different modules of the FDTRU 300. Each module may have a queue to which a pointer to the location of a relevant frame or packet is stored. Other exemplary embodiments of the present invention may use other types of common interfaces, such as but not limited to TDM (time division multiplex) bus, packet based bus, etc. In such an embodiment, each module may have its own memory.

FIG. 4 illustrates a block diagram with relevant elements of an exemplary embodiment of a Standardized Formatter Transmitter Unit (SFTU) 400. The SFTU 400 can be installed between a base station (BS) and a communication link 114 that carries communication to/from the BS. A BS can be a BTS 110a-c, a BSC 130 or an MSC 140. Exemplary SFTU 400 can comprise a Base Station Interface Module (BSIF) 410, a Line Interface Module (LIF) 430, a Filter 420, a Standardized Formatter Module (SFM) 450, a shared memory (SM) 380, a Manager Module (MM) 460 and a communication module (CM) 370. The last three modules MM 460, CM 370 and SM 380 have similar functionality to the relevant modules of FDTRU 300 (FIG. 3) with some adaptation to the needs of SFTU 400 and therefore will not be further described.

The BSIF 410 can handle incoming frames or sub-frames from its associated BS in a similar way to the above-described manner that the BSIF 310 handles incoming frames or sub-frames. The difference between the BSIF 410 and BSIF 310 is the source of the outgoing frames or sub-frames. The BSIF 310 can get outgoing frames or sub-frames from three sources (the LIF 330, the filter 320 and the DFM 340) while the BSIF 410 can get outgoing frames or sub-frames only from the LIF 430. Handling the outgoing frame or sub-frames from the LIF 430 is similar to the process that is disclosed above for handling outgoing frames or sub-frames from the LIF 330 and thus, no further explanation of this process will be provided in conjunction with the description of FIG. 4.

The LIF 430 can handle outgoing frames or sub-frames sent over the communication link 114 in a similar way to the above-described manner that the LIF 330 handles outgoing frames or sub-frames. The difference between the LIF 430 and the LIF 330 is the destination to where incoming frames or sub-frames are routed. The LIF 330 can deliver incoming frames or sub-frames to two modules (to the BSIF 310 and the filter 320) while the LIF 430 can deliver incoming frame or sub-frames only to the BSIF 410. Delivering the incoming frame or sub-frames to the BSIF 410 is similar to the process that is disclosed above for the delivery incoming frames or sub-frames to the BSIF 310 and thus, no further explanation of this process will be provided in conjunction with the description of FIG. 4.

The filter 420 may receive only relevant transportation coming from the BS toward the communication link 114. The filter 420 may receive parsed frames or sub-frames (frames or sub-frames) coming from the BSIF 410 and determine whether to forward the parsed frames or sub-frames to the SFM 450 or to the LIF 430. The decision process may be based on several criteria, which may include, but is not limited to the destination address of the packet, the classification of the content of the payload, determination of whether the payload is speech or noise, a voice activity level, etc.

To define some of the criteria that are associated with the type of the payload, in one exemplary embodiment of the present invention, the encoded audio stream is parsed (partially decompressed) and some of the encoded stream parameters, such as but not limited to Pitch Gain and Fix Code Book Gain, etc., are retrieved and then analyzed to classify the frame or sub frame. More information on the filtering and classification process is disclosed below in conjunction with the explanations of the SFM 450 and in conjunction with the description of FIG. 5. In an alternate embodiment of the present invention, the filter 420 may not be required. The filtering process may be accomplished by the BSIF 410 and/or the SFM 450.

The SFM 450 receives parsed frames coming from the BSIF 410 via the filter 420. The parsed frames may be associated with some classification about their type. The SFM 450 may further analyze the payload for further classification. Based on the classification of the payload and the content of the payload, the payload may be formatted and replaced by corresponding representation information that belongs to a standard format. The standard corresponding representation information can later be used by the destination of the encoded signal, at an MT 120a-h (FIG. 2) or MSC 140 (FIG. 2), for example. The standardized formatted frame or sub-frames include fewer bits than the original frame or sub-frames.

Classifying a frame may be done by parsing or partially decompressing the encoded signal of a received frame, or a sub-frame. To reduce delay, parsing or partially decompress a sub-frame may be started and terminated before receiving the entire frame. Voice parameters are retrieved from the encoded stream. The voice parameters may include parameters, such as but not limited to: line spectrum frequency (LSF), Pitch Gain, Fix Code Book Gain, pitch period, pulse position, etc.

Classifying encoded speech frames or sub-frame may be base on the retrieved parameters. Two main categories may be used, noise or voice. The decision may be based on pitch period and/or energy. A voice frame may be further classified into additional categories, including but not limited to stationary voice, not stationary voice, echo, etc.

For example, the signal energy may be calculated based on a parameter, which can be referred to as the total gain (TG). The TG may be calculated based on the retrieved Pitch Gain and the retrieved Fix Code Book Gain. For example, the TG can be proportional to the sum of those parameters. The SFM 450 may store some or all parameters and may use the stored parameter in processing following frames coming from the same source. Storing the information may be done in the SM 380. For example, the pitch delay may be stored. The differences between a current pitch delay to previous ones may be used to define noise versus speech, etc. Comparing the current pitch period with or without one or more gain parameters to previous ones may be used to define stationary voice, non-stationary voice, echo, etc. More information on the classifying process can be found in U.S. patent application Ser. No. 10/830,081 that is hereby incorporated herein by reference. Based on the classification of the frame or sub-frame, the SFM 450 may select or calculate standardized corresponding representation signals that will replace the original signal. Thus, on the other end of the connection, a DFM 340 is not needed and the formatted frame may be transmitted to the final destination (an MT or MSC). Following are few exemplary processes for creating standardized corresponding representation signals.

If an encoded speech signal frame has been classified as a new noise signal frame, then the encoded parameters that have been defined to represent speech frame may be redefined to represent a noise frame when both representations are based on a standard format. For example, if an original encoded frame had been encoded, according to the AMR standard, as a speech frame but has been classified, by the filter 420 or the SFM 450 as new noise. Then the following process may be used to format a speech AMR encoded frame into a noise AMR encoded frame, having less bits than the original AMR encoded speech frame. The encoded payload is parsed and the line spectrum frequency (LSF) parameters and gain parameters are retrieved; the retrieved LSF parameters are de-quantized. Then the de-quantized LSF parameters are re-quantized according to Silence Descriptor (SID) standard.

The energy of the encoded signal is evaluated based on the retrieved gain parameters. For example, the sum of the two gain parameters of an AMR 12.2 kb/sec frame can be used as an energy parameter. Then, the calculated energy parameter is quantized according to the SID frame format. The formatted payload, which has the format of a standard SID frame, includes fewer bits than the original encoded speech frame. Then the SID frame is transferred to the LIF 430 to be sent all the way to the final destination of the original frame or sub-frame. In an alternate embodiment of the present invention, in which an AMR encoded standard is used, some of the consecutive SID frames may be replaced by No Data Frame indication.

Following is another exemplary process that may be used by the SFM 450 to reduce the number of bits in the transportation over communication link 114 (FIG. 2). If the received encoded signal was encoded according to an AMR 12.2 kb/sec format, then the SFM 450 may format a received speech signal according to 7.95 kb/sec to save bandwidth.

The decision regarding which speech frame can be converted to a lower bit rate can be based on several criteria. For example, the bit rate of frames that have been classified as echo can be reduced. In other embodiments of the present invention, every certain number of speech frames may be transferred as is, and then the bit rate of the following frame may be reduced. In yet another example of the present invention, the communication activity level over the communication path may effect the decision whether to reduce the bit rate of the encoded speech frame or not, etc.

To format a 12.2 kb/sec AMR voice into a 7.95 kb/sec AMR voice encoded frame, the original frame is parsed, partially decoded, and an average set of LSF components is calculated based on the partially decoded two sets of LSF parameters. Then the average set of LSF components is re-quantized according to the AMR 7.95 bit stream format. The retrieved Pitch delay, Pitch Gain and Code Book gain may be re-quantized according to AMR 7.95 bit stream format. Additionally, six pulses have to be removed because an encoded audio steam, which is based on the AMR 12.2 format, includes 5 tracks; each one having two pulses, while an encoded audio steam which is based on the AMR 7.95 format includes 4 tracks; each one has one pulse. Removing pulses may be done in several ways. For example, the pulses may be removed by first searching for 2 pulses with opposite signs and minimal distance and then removing these 2 pulses. Then, this process is repeated until receiving only 4 pulses or until all pulses have the same sign. If there are more than 4 pulses having the same sign, then the search is focused on finding 2 pulses with minimal distance. In this scenario, these 2 pulses are replaced with one pulse with the same sign and in the average position of the 2 pulses. This step is repeated until receiving only 4 pulses.

The positions of the remaining pulses, the last four pulses, are rearranged to create four legal tracks (legal positions) so that each pulse falls in a different track. The new location may be defined by searching for one or more tracks that contain more than one pulse. Then one of the pulses is moved from this track to a track with minimal distance that has no pulse.

If the received encoded signal was encoded according to the AMR 10.2 kb/sec format, then an exemplary SFM 450 may format the received stationary voice frame into a standard 4.75 kb/sec format. Formatting AMR 10.2 kb/sec frames into 4.75 kb/sec frames is more complicated than the above example. The SFM 450 is required to fully decode the received encoded frame or sub-frame. However fully encoding is not required. The decoded LSF parameters are re-quantized according to AMR 4.75 kb/sec format. The fix component is evaluated by using the parameters from the 10.2 bit stream as is further described below, then the fix component is subtracted from the decoded signal. The result of the subtraction (denoted as Signal Period ‘SP’) can be used for evaluating the pitch gain and pitch delay.

Following is a detailed description of exemplary ways for calculating the parameters that are mentioned above. Calculating the new Code Book gain for each pair of sub-frames is done by retrieving the Code Book gain of the first two sub-frames, calculating an average Code Book gain and using it as the Code Book gain of the first pair of sub-frames. The Code Book gain of the last two sub-frames is then retrieved and an average Code Book gain is calculated and then used as the Code Book gain of the second pair of sub-frames.

New pitch delay can be evaluated by evaluating the pitch delay of the 1st sub frame (T1) and 3rd sub frame (T3). The evaluation can be based on the encoded pitch delay index of the 10.2 bit stream and then an open loop pitch search is performed on the ‘SP’. The search is done around T1 and T3. Therefore, the search range is limited to certain segments, for example, [T1−3, T1+3] and [T3−3, T3+3], and not all possible values. After finding the open loop pitch estimation, the closed loop estimation is done for all sub-frames based on the ‘SP’. Then the pitch gain is recalculated directly based on the target signal.

Finally, 6 pulses have to be removed because AMR 10.2 kb/sec formats have 4 tracks of two pulses each, total of 8 pulses and the AMR 4.75 kb/sec format has only 2 pulses. The two remained pulses have to be placed at legal positions for AMR 4.75.

Following is an exemplary method for reducing the number of pulses:
(a) search for 2 pulses with opposite signs and minimal distance;
(b) remove these 2 pulses;
(c) repeat steps (a) and (b) until the required number of pulses is achieved (two pulses for AMR 4.75 kb/sec, for example) or all pulses have the same sign;
(d) determine whether there are more than the required number of pulses (two pulses for AMR 4.75 kb/sec, for example), and if so search for two pulses with minimal distance;
(e) replace these two pulses with one pulse with the same sign and the average position of the two pulses;
(f) repeat steps (d) and (e) until receiving the required number of pulses (two pulses for AMR 4.75 kb/sec, for example).
(g) when the required number of pulses (e.g. two pulses for AMR 4.75 kb/sec) are left, search for a legal position for the required number of pulses (two pulses for AMR 4.75 kb/sec, for example) that yield minimal distance from the pulse position that were received at the end of the pulse drop process; and
(h) organize a standard frame (4.75 kb/sec frame, for example) based on the new parameters which is then transferred to the LIF 430.

FIG. 5 is a flow diagram illustrating the relevant steps in an embodiment of a classifying incoming frames or sub-frames process 500. In one exemplary embodiment of the present invention, the classification process 500 may be executed by the combination of BSIF 310, filter 320 and FM 350. In an alternate embodiment of the present invention the classification process may be executed by the BSIF 310 and filter 320 (FIG. 3). In yet another embodiment, the classification process 500 may be conducted by the BSIF 310 (FIG. 3) and the FM 350. However, for purposes of simplicity of understanding, the disclosed classification process 500 is described as being executed by filter 320.

Process 500 may be initiated upon applying power to the FDTRU 300 (FIG. 3). Upon initiation, the MM 360 (FIG. 3) may allocate 503 the appropriate resources to the filter 320 for performing the classification process. Then, process 500 may wait 506 for a certain period of time, e.g. few milliseconds. At the end of the waiting period, a decision is made 510 whether a pointer to a parsed packet (frame or sub-frame) is waiting in the queue. If the queue is empty, the process 500 may return to step 506.

If there is a parsed packet in the queue, the parsed frame or sub-frame is retrieved 515 from the appropriate location in SM 380 (FIG. 3), the header of the parsed frame or sub-frame is analyzed and a decision is made 520 whether the target of the frame or sub-frame is toward the BSIF 310 (FIG. 3). If the frame or sub-frame is targeted to the BSIF 310, then a decision is made 530 whether the target BS of the frame or sub-frame is the BS that is associated with the FDTRU 300 (associated BS). If the targeted BS is associated with the FDTRU 300, method 500 proceeds to step 532 and a decision is made whether de-formatting is needed. In an alternate embodiment of the present invention, information on the target BS may be retrieved from signaling and control information that is received from the cellular operator. In yet another embodiment of the present invention the target BS is not referred and method 500 may proceed directly from step 520 to step 532.

If 530 the target BS is not the BS is not the associated BS, then the pointer of the parsed frame or sub-frame is transferred 534 to the queue of BSIF 310 (FIG. 3) and method 500 returns to step 506 looking for the next parsed frame or sub-frame in the queue of filter 320 (FIG. 3).

Returning now to step 532, at which a decision is made whether a de-formatting process is needed, to reach a decision, the payload of the packet (frame or sub-frame) may be analyzed looking for a formatted tag. If a formatted tag is found then a pointer to the parsed frame or sub-frame is placed 536 in the queue of the DFM 340 (FIG. 3). If 532 a tag is not found, then the pointer is transferred 534 to the queue of the BSIF 310 (FIG. 3). In an alternate embodiment of the present invention, in which formatted tags are not used, the decision of step 532 can be based on signaling that is sent from the FDTRU 300 that formatted the packet.

Returning now to step 520, if the direction of the frame or sub-frame is not toward the BSIF 310, which means that the direction of the parsed frame or sub-frame is toward the LIF 330 (FIG. 3), then the encoded payload of the frame or sub-frame is analyzed 525 to reach a decision whether 540 the payload can be formatted. Analyzing the payload may comprise further parsing (partially decompressing) the payload, retrieving some of the encoded stream parameters, such as but not limited to Pitch Gain and Fix Code Book Gain, etc. and determining based on those parameters whether the encoded speech frame/sub-frame can be classified as noise, a stationary speech or a non-stationary speech. Information on the analyzing process is disclosed above in conjunction with FIGS. 3 and 4.

In one exemplary embodiment of the present invention, if the received encoded payload has been analyzed as an encoded SID frame, an encoded speech frame/sub-frame that can be classified as new noise, a stationary speech, or echo, then the pointer of the parsed frame or sub-frame can be transferred 544 to the queue of FM 350 (FIG. 3). The pointer can be transferred 542 to the queue of the LIF if the payload has been analyzed 525 as non-stationary speech, for example. In an alternate embodiment of the present invention, an encoded SID payload may also be transferred 542 to the LIF queue.

In an alternate exemplary embodiment of the present invention, the decision of step 540 may be based also on the communication activity level over the communication path of the packet, as it was disclosed above. If the communication activity level is below a certain threshold, then the frame or sub-frame can be transferred 542, as is, to the queue of the LIF 330 and be sent without formatting. In an alternate embodiment of the present invention, the decision, which is based on the communication activity level, may be taken by the BSIF 310.

After transferring the pointer to the parsed frame or sub-frame to the 544 queue of the FM 350 or to the queue 542 of the LIF 330, then process 500 returns to step 506 for processing the next frame or sub-frame in the queue.

A classification process that can be implemented by an exemplary SFTU 400 may have fewer steps than process 500. For instance, steps 520, 530, 532, 534 and 536 are not needed in an SFTU because de-formatting is not required; packets can be transferred directly from LIF 430 to BSIF 410 (FIG. 4).

FIG. 6 is a flow diagram illustrating relevant steps in an embodiment of a formatting frames or sub-frames process 600. Formatting process 600 may be executed by an FM 350 (FIG. 3) or the SFM 450 (FIG. 4). Process 600 may be initiated 603 upon applying power to the FDTRU 300 (FIG. 3) or the SFTU 400 (FIG. 4). Upon initiation, the MM 360 (FIGS. 3 and 4) may allocate the appropriate resources to the FM 350 or the SFM 450 for performing the formatting process. Then, process 600 may wait 606 for a certain period of time, e.g. a few milliseconds. At the end of this waiting period, a decision is made 610 whether a pointer to parsed packet (frame or sub-frame) is waiting in the queue. If the queue is empty, the process 600 may return to step 606.

If a parsed packet is waiting in the queue, the next parsed frame or sub-frame is retrieved from the appropriate location in the SM 380 (FIG. 3) and is processed 612. In an exemplary embodiment of the present invention, in which the filter 320 or 420 (FIGS. 3 or 4, respectively) performs the entire classification process 500 (FIG. 5) the results of the classifications may be stored in the SM 380 in association with the parsed frame or sub-frame. Therefore, the retrieved information can also include the classification of the payload. The payload can be classified as an encoded SID frame/sub-frame, an encoded speech that as been classified as noise, a stationary voice or non-stationary voice, echo, etc. In an embodiment of the present invention in which a portion of the classification process is executed by the FM 350 or the SFM 450, then processing 612 the payload may include the final classification steps.

Based on the classification of the payload and the content of the payload the payload can be formatted 614 and a corresponding representation signal may replace the received encoded payload as is disclosed above in conjunction with the description of the FM 350 and the SFM 450. Then, the formatted payload is stored in the SM 380, instead of the original payload, and a pointer to the location in the SM 380 is transferred 616 to the queue of LIF 330 or 430 (FIGS. 3 or 4, respectively).

FIG. 7 is a flow diagram illustrating the relevant steps in an embodiment of de-formatting frames or sub-frames process 700. Formatting process 700 may be executed by a DFM 340 (FIG. 3). The process 700 may be initiated 703 upon applying power to the FDTRU 300 (FIG. 3). Upon initiation, the MM 360 (FIG. 3) may allocate the appropriate resources to the DFM 340 for performing the de-formatting process. Then, the process 700 may wait 706 for a certain period of time, e.g. a few milliseconds. At the end of the waiting period, a decision is made 710 whether a pointer to parsed packet (frame or sub-frame) is waiting in the queue. If the queue is empty, the process 700 may return to step 706.

If parsed packets are in the queue710, the next parsed frame or sub-frame is retrieved from the appropriate location in the SM 380 (FIG. 3) and is processed 712. In an exemplary embodiment of the present invention, in which the filter 320 (FIG. 3) performs the entire classification process 500 (FIG. 5) the results of the classifications may be stored in the SM 380 in association with the parsed frame or sub-frame. Therefore, the retrieved information can also include the classification of the formatted payload. The formatted payload can be accompanied by the formatted tags that have been added to the formatted payload. In an embodiment of the present invention in which formatted tags are not used, information on the formatting process may be transferred via signaling communication from the FM 350 that has formatted the payload.

Based on the information about the formatted process and history information that is associated with the previously formatted frame or sub-frames of the same connection, the formatted payload can be de-formatted 714 according to a standard format, wherein the de-formatted signal delivers a similar experience as the original encoded signal that was formatted. More information on the de-formatting process is disclosed above in conjunction with the description of the DFM 340. Then, the de-formatted payload is stored in the SM 380 instead of the formatted payload and a pointer to the location in the SM 380 is transferred 716 to the queue of the BSIF.

It will be appreciated that various features of the invention that are, for clarity, described in the contexts of separate embodiments may also be provided in combination in a single embodiment. Conversely, various features of the invention which are, for brevity, described in the context of a single embodiment may also be provided separately or in any suitable sub-combination.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “unit” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A method for reducing a number of bits representing an encoded communication signal represented by a plurality of frames or sub-frames that is transferred over a cellular network between an initiator of the encoded communication signal and a destination of the encoded signal, the method comprising:
a. intercepting the communication of the encoded signal;
b. retrieving encoded parameters from the encoded signal;
c. formatting, based on the retrieved encoded parameters, at least one encoded frame or sub-frame of the encoded signal according to a standard format to create a formatted frame corresponding to the encoded frame or sub-frame, wherein the total number of bits comprised in the formatted frame, is less than the number of bits comprised in said corresponding encoded frame or sub-frame; and
d. transmitting the formatted frame to the destination of the encoded signal.

2. The method of claim 1, further comprising the step of receiving the formatted frame at the destination of the encoded signal.

3. The method of claim 1, wherein the encoded parameters contain at least one parameter selected from the group consisting of line spectrum frequency (LSF), pitch period and pulse position.

4. The method of claim 1, wherein the encoded parameters contain at least one parameter selected from the group consisting of Pitch Gain and Fix Code Book Gain.

5. The method of claim 1, wherein the formatting step further comprises the steps of:
classifying the at least one encoded frame or sub-frame and;
formatting the at least one encoded frame or sub-frame based on the classification.

6. The method of claim 5, wherein the at least one encoded speech frame or sub-frame has a low signal energy, and the step of classifying the at least one encoded frame further comprises classifying the at least one encoded frame as new noise.

7. The method of claim 6, wherein the at least one encoded speech frame or sub-frame that was classified has new noise, and wherein the step of formatting the at least one encoded frame or sub-frame further comprises the step of formatting the at least one encoded frame or sub-frame into a SID (Silence Descriptor) frame or sub-frame.

8. The method of claim 1, wherein the intercepted encoded signal was encoded according to an adaptive multi-rate (AMR) format and, the formatting step further comprises the steps of:
classifying the at least one encoded frame or sub-frame and;
formatting the at least one encoded frame or sub-frame based on the classification.

9. The method of claim 7, wherein the encoded communication signal has been encoded according to an adaptive multi-rate (AMR) format at a bit rate of 12.2 kb/sec and the formatting step further comprises the step of formatting the at least one encoded frame or sub-frame at bit rate of 7.95 kb/sec.

10. The method of claim 7, wherein the encoded communication signal has been encoded according to an adaptive multi-rate (AMR) format at a bit rate of 10.2 kb/sec and the formatting step further comprises the step of formatting the at least one encoded frame or sub-frame at bit rate of 4.75 kb/sec.

11. The method of claim 7, wherein the formatting the at least one encoded frame or sub-frame further comprising:
(i) selecting two or more pulses;
(ii) removing the selected two or more pulses; and
(iii) repositioning the remained pulses according to the AMR standard format.

12. The method of claim 1, wherein the network is a 3G network including an MSC and an RNC and the step of intercepting the communication of the encoded signal comprises intercepting the encoded signal between the MSC and RNC.

13. The method of claim 2, wherein the destination of the encoded signal is a mobile terminal and further comprising the step of the destination of the encoded signal receiving the formatted frame.

14. The method of claim 2, wherein the formatted frame is received by an intermediate node prior to being received by the destination.

15. A method for reducing the number of bits representing an encoded communication signal represented by a plurality of frames, wherein the encoded communications signal is transferred over a cellular network between an initiator of the encoded communication signal and a destination of the encoded signal, the method comprising the steps of:
a. intercepting the communication of the encoded signal;
b. retrieving encoded parameters from the encoded signal;
c. formatting, based on the retrieved encoded parameters, at least one encoded frame or sub-frame of the encoded signal according to a non-standard format to create a formatted frame corresponding to the encoded frame or sub-frame, wherein the total number of bits comprised in formatted frame is less than the number of bits comprised in said encoded frame or sub-frame;
d. transmitting the formatted frame toward the destination of the encoded signal via an intermediate node;
e. de-formatting the formatted frame at the intermediate node; and
f. further transmitting the de-formatted formatted frame to the destination of the encoded signal.

16. The method of claim 15, wherein the at least one encoded frame or sub-frame comprises a first number of pulses and the step of formatting the at least one encoded frame or sub-frame comprises the step of reducing the number of pulses from the first number of pulses to a second number of pulses, wherein the second number of pulses do not comply with a standard format.

17. The method of claim 15, wherein the formatting step further comprises the steps of:
classifying the at least one frame or sub-frame of the intercepted encoded signal; and
formatting the at least one frame or sub-frame based on the classification.

18. The method of claim 17, wherein the at least one frame or sub-frame is classified as encoded voice signal.

19. A method for reducing a number of bits representing an encoded communication signal represented by a plurality of frames or sub-frames that is transferred over a cellular network between an initiator of the encoded communication signal and a destination of the encoded signal, the method comprising the steps of:
a. intercepting the communication of the encoded signal;
b. selecting an encoded frame or a sub-frame of the encoded signal as a base frame;
c. retrieving encoded parameters from the base frame;
d. transmitting, the encoded base frame as is, toward the destination of the encoded signal via an intermediate node;
e. calculating differences of one or more encoded parameters of a next encoded frame from the similar encoded parameters of the base frame;
f. formatting the next encoded frame using the difference of the encoded parameters, wherein the total number of bits comprised in a formatted frame is less than the number of bits comprised in the corresponding encoded frame;
g. transmitting the next formatted frame toward the destination of the encoded signal via the intermediate node;
h. de-formatting the next formatted frame based at least in part on the intermediate node; and
i. further transmitting the d e-formatted next formatted frame to the destination of the encoded signal.

20. The method of claim 19, wherein the encoded signal is an encoded audio signal and the classifying step further comprises classifying the frame based on the audio characteristics.

21. The method of claim 20, wherein the intercepted encoded signal was encoded according to an adaptive multi-rate (AMR) format.

22. The method of claim 20, wherein the classification containing at least one type selected from the group consisting of a stationary frame, a transition frame between phonemes, a silence frame and a background noise frame.

23. A method for reducing a number of bits representing an encoded communication signal, wherein the encoded communication signal is comprised of a plurality of frames or sub-frames and is transferred over a cellular network between an initiator of the encoded communication signal and a destination of the encoded signal, the method comprising:
a. intercepting the communication of the encoded signal;
b. retrieving encoded parameters from the encoded signal;
c. formatting, based on the encoded parameters, at least one encoded frame or sub-frame to create a formatted frame corresponding to the encoded frame or sub-frame, wherein the total number of bits comprised in the formatted frame, is less than the number of bits comprised in said corresponding encoded frame or sub-frame; and
d. transmitting the formatted frame toward the destination of the encoded signal via the intermediate node; and
e. further transmitting the formatted frame to the destination.

24. The method of claim 23, wherein the step of formatting the at least one encoded frame or sub-frame comprises encoding the encoded frame according to a standard format.

25. The method of claim 23, wherein the step of formatting the at least one encoded frame or sub-frame comprises encoding the encoded frame according to a non-standard format.

26. The method of claim 23, wherein the step of formatting the at least one encoded frame or sub-frame further comprises the steps of:
selecting an encoded frame or a sub-frame of the encoded signal as a base frame;
transmitting the encoded base frame, as is, toward the destination of the encoded signal via the intermediate node;
calculating differences of one or more encoded parameters of a next encoded frame from the same encoded parameters of the base frame; and
formatting the next encoded frame using the difference of the encoded parameters, wherein the total number of bits comprised in a formatted frame is less than the number of bits comprised in the corresponding encoded frame.
